(19) United States
(12) Patent Application Publication
(10) Pub. No.: US 2008/0076850 A1
(43) Pub. Date: Mar. 27, 2008

(54) PRODUCTION METHOD OF INSULATING FILM, INSULATING FILM, STACKED PRODUCT AND ELECTRONIC DEVICE

(75) Inventor: Akira ASANO, Haibara-gun (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 11/853,325

(22) Filed: Sep. 11, 2007

(30) Foreign Application Priority Data
Sep. 22, 2006 (JP) 2006-257279

(51) Int. Cl. C08F 2/46

(52) U.S. Cl. 522/172; 522/184

(57) ABSTRACT

A production method of an insulating film includes a process of applying a film forming composition to form a film; and a process of irradiating the film with at least two kinds of high energy rays to cure the film.

### BACKGROUND OF THE INVENTION

1. Field of the Invention

The present invention relates to a process for producing an insulating film good in film properties such as dielectric constant, adhesion, mechanical strength and heat resistance; an insulating film produced by the production process; a stacked product obtained by stacking the insulating film; and an electronic device produced using the insulating film or stacked product.

2. Description of the Related Art

In recent years, with the progress of high integration, multifunction and high performance in the field of electronic materials, circuit resistance and condenser capacity between interconnects have increased and have caused an increase in electric power consumption and delay time. Particularly, the increase in delay time becomes a large factor for reducing the signal speed of devices and generating crosstalk. Reduction of parasitic resistance and parasitic capacity are therefore required in order to reduce this delay time, thereby attaining speed-up of devices. As one of the concrete measures for reducing this parasitic capacity, an attempt has been made to cover the periphery of an interconnect with a low dielectric interlayer insulating film. The interlayer insulating film is expected to have superior heat resistance in the thin film formation step when a printed circuit board is manufactured or in post steps such as chip connection and pin attachment and also chemical resistance in the wet process. In addition, a low resistance Cu interconnect has been introduced in recent years instead of an Al interconnect, and along with this, CMP (chemical mechanical polishing) has been employed commonly for planarization of the film surface. Accordingly, an insulating film having high mechanical strength and capable of withstanding this CMP step is required.

As a material of highly heat-resistant interlayer insulating films, polybenzoxazole, polyimide, polyarylene (ether) and the like have been disclosed for long years. There is however a demand for the development of materials having a lower dielectric constant in order to realize a high speed device. Introduction of a hetero atom such as oxygen, nitrogen or sulfur or an aromatic hydrocarbon unit into the molecule of a polymer as in the above-described materials, however, increases a dielectric constant owing to high molar polarization, causes a time-dependent increase in the dielectric constant owing to moisture absorption, or causes a trouble impairing reliability of an electronic device so that these materials need improvement.

A polymer composed of a saturated hydrocarbon has advantageously a lower dielectric constant because it has smaller molar polarization than a polymer composed of a hetero-atom-containing unit or aromatic hydrocarbon unit. For example, however, a hydrocarbon such as polyethylene having high flexibility has insufficient heat resistance and therefore cannot be used for electronic devices.

Polymers having, in the molecule thereof, a saturated hydrocarbon having a rigid cage structure such as adamantane or diamantane are disclosed (EP 1605016 A2). Adamantane or diamantane is a preferable unit because it has a diamondoid structure and exhibits high heat resistance and low dielectric constant. Since such a hydrocarbon polymer has however usually low adhesion to an underlying film, it is required to have improved adhesion.

It is the common practice to form the above-described interlayer insulating film by applying a coating solution onto a wafer and then curing for at least 30 minutes at a temperature of 350° C. or greater in an electric oven. Owing to recent limited production of a wide variety of semiconductor devices, treatment in an electric furnace, which is typical of batch treatment tends to be avoided. As a process that permits single wafer treatment and can replace thermal crosslinking, use of ultraviolet rays (JP-A-2005-45138 (the term “JP-A” as used herein means an unexamined published Japanese patent application) or use of electron beam (JP-A-2003-297819) is proposed. These processes are under brisk development because they require only a short curing time and owing to a decrease in heating time, are effective for reducing the thermal budget. It is however pointed out in JP-A-2005-45138 that when curing is performed by exposure to only electron beam, chemical bonds in an insulating film are damaged by the excessive irradiation of electron beam. Accordingly, adhesion is sometimes deteriorated not by breakage on the interface between the insulating film and underlying film but that inside of the insulating film. When curing is performed by exposure to only ultraviolet rays, on the other hand, crosslinking reaction proceeds in the insulating film, but formation of chemical bonds on the interface between the insulating film and underlying film does not occur easily only by the energy of ultraviolet rays. The adhesion is therefore sometimes deteriorated by the breakage on just the interface between the insulating film and underlying film.

### SUMMARY OF THE INVENTION

The present invention provides a process for producing an insulating film superior in film properties such as dielectric constant, adhesion, mechanical strength and heat resistance, an insulating film produced by the above-described process, a stacked product obtained by stacking the insulating film, and an electronic device obtained using the insulating film or stacked product. An “insulating film” is also referred to as a “dielectric film” or a “dielectric insulating film”, and these terms are not substantially distinguished.

As a result of detailed investigation of a curing process by using an electron beam or ultraviolet ray, the present inventors have found to their surprise that excellent adhesion can be achieved by curing using at least two kinds of high energy rays. This is presumed to be achieved because both a portion suited for exposure to electron beam and another portion suited for exposure to ultraviolet radiation are present at the interface between the inside of the polymer which is amorphous and an underlying film. Curing of these portions therefore progresses ideally by exposing to at least two kinds of high energy rays, whereby an interfacial chemical bond between the inside of the film and the underlying film is formed ideally.

The present inventors have found that the above-described problems can be overcome by the following constitutions <1> to <15>.

<1> A production method of an insulating film, comprising:

a process of applying a film forming composition to form a film; and

a process of irradiating the film with at least two kinds of high energy rays to cure the film.

<2> The production method as described in <1>,

wherein the at least two kinds of high energy rays are selected from the group consisting of electron beam, ultraviolet ray, X-ray and microwave.

<3> The production method as described in <1>,

wherein the film is heated to 150 to 400° C. at the process of irradiating film.

<4> The production method as described in <3>, further comprising:

a process of cooling the film to less than 150° C. between respective irradiations of the film with respective high energy rays.

<5> The production method as described in <1>,

wherein the film forming composition comprises a compound having a cage structure.

<6> The production method as described in <5>,

wherein the compound having a cage structure is a polymer of a monomer having a cage structure.

<7> The production method as described in <6>,

wherein the monomer having a cage structure has a polymerizable carbon-carbon double bond or carbon-carbon triple bond.

<8> The production method as described in <5>,

wherein the cage structure is selected from the group consisting of adamantane, biadamantane, diamantane, triamantane and tetramantane.

<9> The production method as described in <6>,

wherein the monomer having a cage structure is selected from the group consisting of compounds represented by the following formulas (I) to (VI):

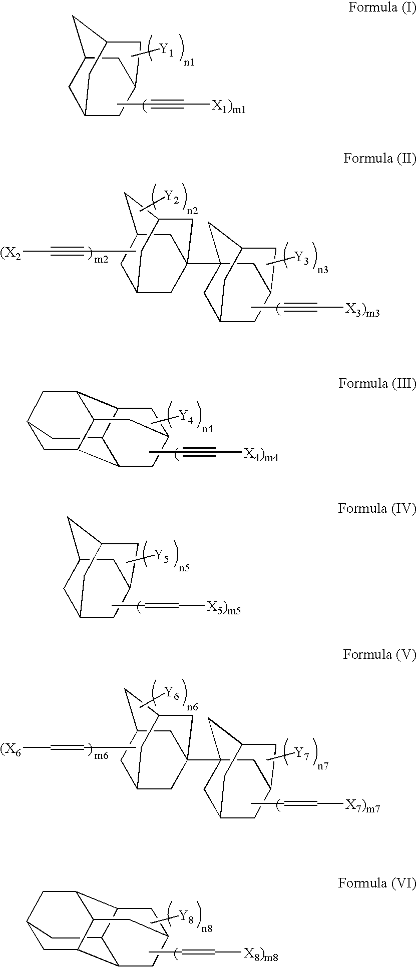

wherein, X₁(s) to X₈(s) each independently represents a hydrogen atom, C₁₋₁₀ alkyl group, C₂₋₁₀ alkenyl group, C₂₋₁₀ alkynyl group, C₆₋₂₀ aryl group, C₀₋₂₀ silyl group, C₂₋₁₀ acyl group, C₂₋₁₀ alkoxycarbonyl group, or C₁₋₂₀ carbamoyl group;

Y₁(s) to Y₈(s) each independently represents a halogen atom, C₁₋₁₀ alkyl group, C₆₋₂₀ aryl group or C₀₋₂₀ silyl group;

m₁ and m₅ each independently represents an integer of 1 to 16;

n₁ and n₅ each independently represents an integer of 0 to 15;

m₂, m₃, m₆ and m₇ each independently represents an integer of 1 to 15;

n₂, n₃, n₆ and n₇ each independently represents an integer of 0 to 14;

m₄ and m₈ each independently represents an integer of 1 to 20; and

n₄ and n₈ each independently represents an integer of 0 to 19.

<10> The production method as described in 6,

wherein the compound having a cage structure is obtained by polymerizing the monomer having a cage structure in the presence of a transition metal catalyst or a radical polymerization initiator.

<11> The production method as described in <5>,

wherein the compound having a cage structure has a solubility of 3 mass % or greater in cyclohexanone or anisole at 25° C.

<12> An insulating film produced by the production method as described in <1>.

<13> A stacked product obtained by stacking the insulating film as described in <12>.

<14> An electronic device comprising:

the insulating film as described in <12>.

<15> An electronic device comprising:

the stacked product as described in <13>.

### BRIEF DESCRIPTION OF THE DRAWING

FIG. 1A is a flow chart for explaining a conventional formation step of an insulating film for semiconductor devices; and

FIG. 1B is a flow chart for explaining the formation step of an insulating film according to the invention.

### DETAILED DESCRIPTION OF THE INVENTION

The present invention will hereinafter be described specifically.

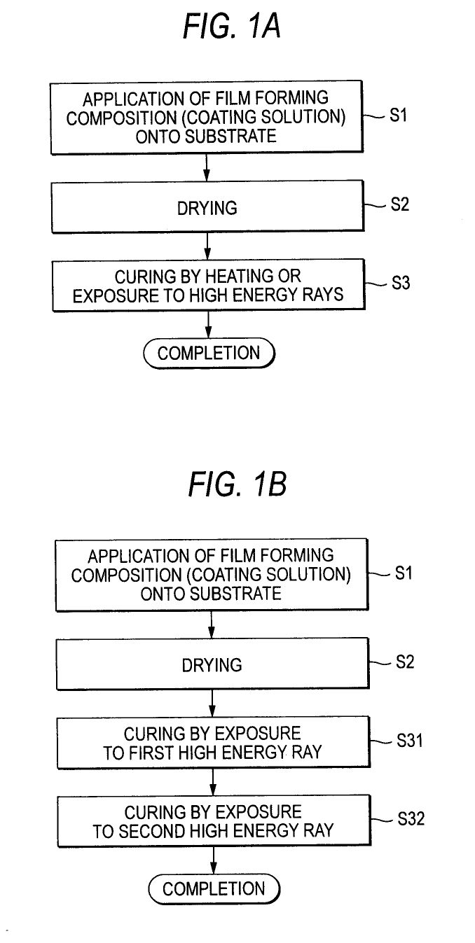

The invention is characterized in that it has a step of curing a film, which has been formed by the application of a film forming composition, by exposing it to at least two kinds of high energy rays. A conventional production process of an insulating film for semiconductor devices comprises a step of applying a film forming composition onto a substrate (S1) as illustrated in FIG. 1A, a drying step (S2) and a curing step (S3) by heat or exposure to one kind of a high energy ray. The production process according to the invention, on the other hand, comprises, as illustrated in FIG. 1B, an application step (S1) and a drying step (S2), which are similar to those illustrated in FIG. 1A, and a curing step composed of curing (S31) by exposure to a first high energy ray and curing (S32) by exposure to a second high energy ray. Although not illustrated in the drawing, the curing (S32) by exposure to a second high energy ray may be followed by exposure to a third high energy ray. If necessary, the exposure to a third high energy ray may be followed by successive exposure to a fourth high energy ray and a fifth high energy ray.

Examples of the high energy ray in the invention include, but not particularly limited to, electron beam, ultraviolet ray, X ray and microwave. The order of the exposure is not particularly limited. Examples of the substrate that lies below the film forming composition in the invention include, but not particularly limited to, Si substrate, SOI substrate, glass substrate and plastic substrate. The substrate over which a transistor or interconnection structure has already been formed may also be usable.

When an electron beam is selected as the high energy ray, its energy is preferably from 0 to 50 keV, more preferably from 0 to 30 keV, especially preferably from 0 to 20 keV The total dose amount of the electron beam is preferably from 0 to 5 μC/cm², more preferably from 0 to 2 μC/cm², especially preferably from 0 to 1 μC/cm². The film temperature at the time of exposure to the electron beam is preferably from 0 to 450° C., more preferably from 150 to 400° C., especially preferably from 250 to 375° C. Pressure is preferably from 0 to 133 kPa, more preferably from 0 to 60 kPa, especially preferably from 0 to 20 kPa. In order to prevent the oxidation of a film forming compound, the substrate is placed preferably in an inert atmosphere such as Ar, He or nitrogen. The oxygen concentration of the atmosphere is preferably 1000 ppm or less, more preferably 500 ppm or less, especially preferably 100 ppm or less. Oxygen, hydrocarbon, ammonia or the like gas may be added to cause reaction with plasma, electromagnetic wave or chemical species to be generated by the interaction with the electron beam.

When an ultraviolet ray is selected as the high energy ray, its radiation wavelength range is preferably from 190 to 400 nm and its output immediately above the substrate is preferably from 0.1 to 2000 mWcm⁻².

The film temperature at the time of exposure to ultraviolet radiation is preferably from 150 to 400° C., more preferably from 250 to 400° C., especially preferably from 250 to 375° C. In order to prevent the oxidation of the film forming compound, the substrate is placed preferably in an atmosphere of an inert gas such as Ar, He or nitrogen. The oxygen concentration of the atmosphere is preferably 1000 ppm or less, more preferably 500 ppm or less, especially preferably 100 ppm or less. The pressure during exposure is preferably from 0 to 133 kPa.

When an X-ray is selected as the high energy ray, examples of the X-ray include, but not particularly limited to, CuKα ray (wavelength: 0.15418 nm), MoKα ray (wavelength: 0.071073 nm), and white X ray and monochromatic X-ray, each an irradiation light. The output of it is preferably from 0.1 to 2000 mWcm⁻² immediately above the substrate.

The film temperature at the time of exposure to an X ray is preferably from 150 to 400° C., more preferably from 250 to 400° C., especially preferably from 250 to 375° C. In order to prevent the oxidation of the film forming compound, the substrate is placed preferably in an atmosphere of an inert gas such as Ar, He or nitrogen. The oxygen concentration of the atmosphere is preferably 1000 ppm or less, more preferably 500 ppm or less, especially preferably 100 ppm or less. The pressure during exposure is preferably from 0 to 133 kPa.

When a microwave is selected as the high energy ray, examples of it include, but not particularly limited to, microwave (wavelength: 12 cm) of a 2.45 GHz band. The output of it is preferably from 0.1 to 2000 mWcm⁻² immediately above the substrate. The film temperature at the time of exposure to a microwave is preferably from 150 to 400° C., more preferably from 250 to 400° C., especially preferably from 250 to 375° C. In order to prevent the oxidation of the film forming compound, the substrate is placed preferably in an atmosphere of an inert gas such as Ar, He or nitrogen. The oxygen concentration of the atmosphere is preferably 1000 ppm or less, more preferably 500 ppm or less, especially preferably 100 ppm or less. The pressure during exposure is preferably from 0 to 133 kPa.

The term “microwave” as used herein means an electromagnetic wave having a wavelength of from about 10 to 100 mm; the term “ultraviolet ray” means an electromagnetic wave having a wavelength of from about 10 to 400 nm; and the term “X ray” means an electromagnetic wave having a wavelength of from about 1 pm to 10 nm. The term “electron beam” means a flow of electrons accelerated by any electric field.

In the invention, the at least two kinds of high energy rays include preferably electron beam and ultraviolet ray.

When exposures to high energy rays are performed successively and there is a time interval between these successive exposures, it is preferred to cool the film once to less than 150° C. in order to prevent oxidation. The term “film is exposed to at least two kinds of high energy rays successively” as used herein means that the film is exposed to at least two high energy rays at any stage during the curing step. The film can be subjected to exposures to high energy rays without any time interval between them, exposures to high energy rays while having a time interval therebetween as described above, or simultaneous exposure to at least two high energy rays.

It is also possible to stack films made of several kinds of film forming compositions and then carry out simultaneous curing of them.

The film forming composition of the invention contains preferably a compound having a cage structure.

The term “cage structure” as used herein means a molecule whose space is defined by a plurality of rings formed by covalent-bonded atoms and a point existing within the space cannot depart from the space without passing through these rings. For example, an adamantane structure may be considered as the cage structure. Contrary to this, a single crosslink-having cyclic structure such as norbornane (bicyclo[2,2,1]heptane) cannot be considered as the cage structure because the ring of the single-crosslinked cyclic compound does not define the space of the compound.

The cage structure of the invention may contain either a saturated bond or unsaturated bond and may contain a hetero atom such as oxygen, nitrogen or sulfur. A saturated hydrocarbon is however preferred from the viewpoint of a low dielectric constant.

Preferred examples of the cage structure of the invention include adamantane, biadamantane, diamantane, triamantane, tetramantane and dodecahedrane, of which adamantane, biadamantane and diamantane are more preferred. Of these, biadamantane and diamantane are especially preferred, because they have a low dielectric constant.

The cage structure according to the invention may have one or more substituents. Examples of the substituents include halogen atoms (fluorine, chlorine, bromine and iodine), linear, branched or cyclic C₁₋₁₀ alkyl groups (such as methyl, t-butyl, cyclopentyl and cyclohexyl), C₂₋₁₀ alkenyl groups (such as vinyl and propenyl), C₂₋₁₀ alkynyl groups (such as ethynyl and phenylethynyl), C₆₋₂₀ aryl groups (such as phenyl, 1-naphthyl and 2-naphthyl), C₂₋₁₀ acyl groups (such as benzoyl), C₂₋₁₀ alkoxycarbonyl groups (such as methoxycarbonyl), C₁₋₁₀ carbamoyl groups (such as N,N-diethylcarbamoyl), C₆₋₂₀ aryloxy groups (such as phenoxy), C₆₋₂₀ arylsulfonyl groups (such as phenylsulfonyl), nitro group, cyano group, and silyl groups (such as triethoxysilyl, methyldiethoxysilyl and trivinylsilyl).

The cage structure according to the invention is preferably divalent, trivalent or tetravalent. In this case, a group to be coupled to the cage structure may be a substituent having a valence of one or more or a linking group having a valence of two or more. The cage structure is more preferably divalent or trivalent, especially preferably divalent.

The compound having a cage structure to be used in the invention is preferably a polymer of a monomer having a cage structure. The term “monomer” as used herein means a molecule which will be a dimer or higher polymer by the polymerization of the molecules. The polymer may be either a homopolymer or a copolymer.

The polymerization reaction of the monomer is caused by a polymerizable group substituted to the monomer. The term “polymerizable group” as used herein means a reactive substituent that causes polymerization of a monomer. Although any polymerization reaction can be employed, examples include radical polymerization, cationic polymerization, anionic polymerization, ring-opening polymerization, polycondensation, polyaddition, addition condensation and polymerization in the presence of a transition metal catalyst.

The polymerization reaction of a monomer in the invention is preferably carried out in the presence of a non-metallic polymerization initiator. For example, a monomer having a polymerizable carbon-carbon double bond or carbon-carbon triple bond can be polymerized in the presence of a polymerization initiator that generates free radicals such as carbon radicals or oxygen radicals by heating and thereby shows activity.

As the polymerization initiator, organic peroxides and organic azo compounds are preferred, of which organic peroxides are especially preferred.

Preferred examples of the organic peroxides include ketone peroxides such as “PERHEXA H”, peroxyketals such as “PERHEXA TMH”, hydroperoxides such as “PERBUTYL H-69”, dialkylperoxides such as “PERCUMYL D”, “PERBUTYL C” and “PERBUTYL D”, diacyl peroxides such as “NYPER BW”, peroxy esters such as “PERBUTYL Z” and “PERBUTYL L”, and peroxy dicarbonates such as “PEROYL TCP”, (each, trade name; commercially available from NOF Corporation), diisobutyryl peroxide, cumylperoxyneodecanoate, di-n-propylperoxydicarbonate, diisopropylperoxydicarbonate, di-sec-butylperoxydicarbonate, 1,1,3,3-tetramethylbutylperoxyneodecanoate, di(4-t-butylchlorohexyl)peroxydicarbonate, di(2-ethylhexyl)peroxydicarbonate, t-hexylperoxyneodecanoate, t-butylperoxyneodecanoate, t-butylperoxyneoheptanoate, t-hexylperoxypivalate, t-butylperoxypivalate, di(3,5,5-trimethylhexanoyl)peroxide, dilauroyl peroxide, 1,1,3,3-tetramethylbutylperoxy-2-ethylhexanoate, disuccinic acid peroxide, 2,5-dimethyl-2,5-di(2-ethylhexanoylperoxy)hexane, t-hexylperoxy-2-ethylhexanoate, di(4-methylbenzoyl)peroxide, t-butylperoxy-2-ethylhexanoate, di(3-methylbenzoyl)peroxide, benzoyl(3-methylbenzoyl)peroxide, dibenzoyl peroxide, 1,1-di(t-butylperoxy)-2-methylcyclohexane, 1,1-di(t-hexylperoxy)-3,3,5-trimethylcyclohexane, 1,1-di(t-hexylperoxy)cyclohexane, 1,1-di(t-butylperoxy)cyclohexane, 2,2-di(4,4-di-(t-butylperoxy)cyclohexyl)propane, t-hexylperoxyisopropyl monocarbonate, t-butylperoxymaleic acid, t-butylperoxy-3,5,5-trimethylhexanoate, t-butylperoxylaurate, t-butylperoxyisopropylmonocarbonate, t-butylperoxy-2-ethylhexylmonocarbonate, t-hexylperoxybenzoate, 2,5-dimethyl-2,5-di(benzoylperoxy)hexane, t-butylperoxyacetate, 2,2-di-(t-butylperoxy)butane, t-butylperoxybenzoate, n-butyl-4,4-di-t-butylperoxyvalerate, di(2-t-butylperoxyisopropyl)benzene, dicumyl peroxide, di-t-hexyl peroxide, 2,5-dimethyl-2,5-di(t-butylperoxy)hexane, t-butylcumyl peroxide, di-t-butyl peroxide, p-methane hydroperoxide, 2,5-dimethyl-2,5-di(t-butylperoxy)hexine-3, diisopropylbenzene hydroperoxide, 1,1,3,3-tetramethylbutyl hydroperoxide, cumene hydroperoxide, t-butyl hydroperoxide, 2,3-dimethyl-2,3-diphenylbutane, 2,4-dichlorobenzoyl peroxide, o-chlorobenzoyl peroxide, p-chlorobenzoyl peroxide, tris-(t-butylperoxy)triazine, 2,4,4-trimethylpentylperoxyneodecanoate, α-cumylperoxyneodecanoate, t-amylperoxy-2-ethylhexanoate, t-butylperoxyisobutyrate, di-t-butylperoxyhexahydroterephthalate, di-t-butylperoxytrimethyladipate, di-3-methoxybutylperoxydicarbonate, di-isopropylperoxydicarbonate, t-butylperoxyisopropylcarbonate, 1,6-bis(t-butylperoxycarbonyloxy)hexane, diethylene glycol bis(t-butylperoxycarbonate) and t-hexylperoxyneodecanoate.

Examples of the organic azo compound include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, and azoamidine compounds such as “V-50” and VA-057” (each, trade name; commercially available from Wako Pure Chemical Industries), 2,2-azobis(4-methoxy-2,4-dimethylvaleronitrile), 2,2-azobis(2,4-dimethylvaleronitrile), 2,2-azobis(2-methylpropionitrile), 2,2-azobis(2,4-dimethylbutyronitrile), 1,1-azobis(cyclohexane-1-carbonitrile), 1-[(1-cyano-1-methylethyl)azo]formamide, 2,2-azobis{2-methyl-N-[1,1-bis(hydroxymethyl)-2-hydroxyethyl]propionamide}, 2,2-azobis[2-methyl-N-(2-hydroxybutyl)propionamide], 2,2-azobis[N-(2-propenyl)-2-methylpropionamide], 2,2-azobis(N-butyl-2-methylpropionamide), 2,2-azobis(N-cyclohexyl-2-methylpropionamide), 2,2-azobis[2-(2-imidazolin-2-yl)propane]dihydrochloride, 2,2-azobis[2-(2-imidazolin-2-yl)]propane]disulfate dihydrate, 2,2-azobis{2-[1-(2-hydroxyethyl)-2-imidazolin-2-yl]propane}dihydrochloride, 2,2-azobis[2-[2-imidazolin-2-yl]propane], 2,2-azobis(1-imino-1-pyrrolidino-2-methylpropane)dihydrochloride, 2,2-azobis(2-methylpropionamidine)dihydrochloride, 2,2-azobis[N-(2-carboxyethyl)-2-methylpropionamidine]tetrahydrate, dimethyl-2,2-azobis(2-methylpropionate), 4,4-azobis(4-cyanovaleric acid) and 2,2-azobis(2,4,4-trimethylpentane).

In the invention, these polymerization initiators may be used either singly or as a mixture.

The amount of the polymerization initiator in the invention is preferably from 0.001 to 2 moles, more preferably from 0.01 to 1 mole, especially preferably from 0.05 to 0.5 mole, per mole of a monomer.

In the invention, the polymerization reaction of a monomer may be effected preferably in the presence of a transition metal catalyst. For example, it is preferred to carry out polymerization of a monomer having a polymerizable carbon-carbon double bond or carbon-carbon triple bond, for example, in the presence of a Pd catalyst such as Pd(PPh₃)₄ or Pd(OAc)₂, a Ziegler-Natta catalyst, an Ni catalyst such as nickel acetyl acetonate, a W catalyst such as WCl₆, an Mo catalyst such as MoCl₅, a Ta catalyst such as TaCl₅, an Nb catalyst such as NbCl₅, an Rh catalyst or a Pt catalyst.

In the invention, these transition metal catalysts may be used either singly or as a mixture.

In the invention, the amount of the transition metal catalyst is preferably from 0.001 to 2 moles, more preferably from 0.01 to 1 mole, especially preferably from 0.05 to 0.5 mole per mole of the monomer.

The cage structure in the invention may have been substituted as a pendant group in the polymer or may have become a portion of the polymer main chain, but latter is preferred. When the cage structure has become a portion of the polymer main chain, the polymer chain is broken by the removal of the cage compound from the polymer. In this mode, the cage structure may be directly single-bonded or linked by an appropriate divalent linking group. Examples of the linking group include —C(R₁₁)(R₁₂)—, —C(R₁₃)═C(R₁₄)—, —C≡C—, arylene group, —CO—, —O—, —SO₂—, —N(R₁₅)—, and —Si(R₁₆)(R₁₇)—, and combination thereof. In these groups, R₁₁ to R₁₇ each independently represents a hydrogen atom, an alkyl group, an alkenyl group, an alkynyl group or an aryl group. These linking groups may be substituted by a substituent and the above-described substituents are preferably employed as it.

Of these, —C(R₁₁)(R₁₂)—, —CH═CH—, —C≡C—, arylene group, —O— and —Si(R₁₆)(R₁₇)—, and combination thereof are more preferred, with —C(R₁₁)(R₁₂)— and —CH═CH— being especially preferred in consideration of a low dielectric constant.

The compound having a cage structure according to the invention may be either a low molecular compound or high molecular compound (for example, polymer), but is preferably a polymer. When the compound having a cage structure is a polymer, its weight average molecular weight is preferably from 1000 to 500000, more preferably from 5000 to 200000, especially preferably from 10000 to 100000. The polymer having a cage structure may be contained, as a resin composition having a molecular weight distribution, in a film forming coating solution. When the compound having a cage structure is a low molecular compound, its molecular weight is preferably from 150 to 3000, more preferably from 200 to 2000, especially preferably from 220 to 1000.

The compound having a cage structure according to the invention is preferably a polymer of a monomer having a polymerizable carbon-carbon double bond or carbon-carbon triple bond. The compound is more preferably a polymer of a compound represented by any one of the below-described formulas (I) to (VI).

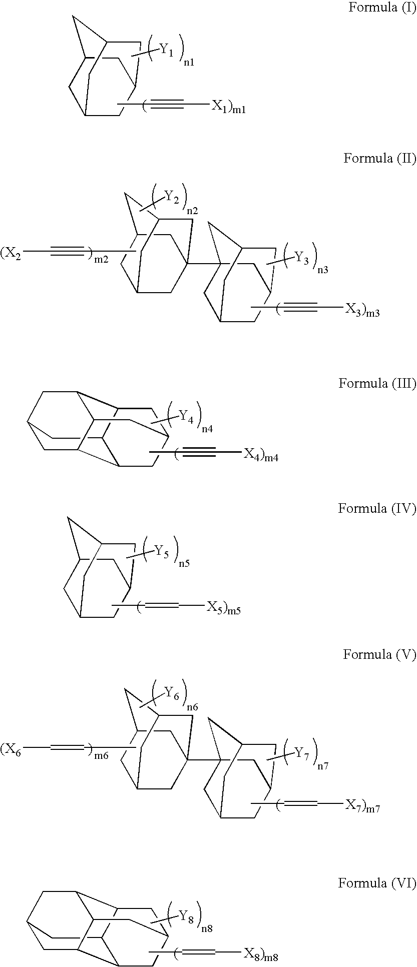

In the formulas (I) to (VI),

X₁(s) to X₈(s) each independently represents a hydrogen atom, a C₁₋₁₀ alkyl group, a C₂₋₁₀ alkenyl group, a C₂₋₁₀ alkynyl group, a C₆₋₂₀ aryl group, a C₀₋₂₀ silyl group, a C₂₋₁₀ acyl group, a C₂₋₁₀ alkoxycarbonyl group, or a C₁₋₂₀ carbamoyl group, of which hydrogen atom, C₁₋₁₀ alkyl group, C₆₋₂₀ aryl group, C₀₋₂₀ silyl group, C₂₋₁₀ acyl group, C₂₋₁₀ alkoxycarbonyl group, or C₁₋₂₀ carbamoyl group is preferred; hydrogen atom or C₆₋₂₀ aryl group is more preferred; and hydrogen atom is especially preferred.

Y₁(s) to Y₈(s) each independently represents a halogen atom (fluorine, chlorine, bromine or the like), a C₁₋₁₀ alkyl group, a C₆₋₂₀ aryl group, or a C₀₋₂₀ silyl group, of which a C₁₋₁₀ alkyl group or C₆₋₂₀ aryl group which may have a substituent is more preferred and an alkyl (methyl or the like) group is especially preferred.

X₁ to X₈ and Y₁ to Y₈ may each be substituted by another substituent.

In the above formulas,

m₁ and m₅ each independently stands for an integer from 1 to 16, preferably from 1 to 4, more preferably from 1 to 3, especially preferably 2;

n₁ and n₅ each independently stands for an integer from 0 to 15; preferably from 0 to 4, more preferably 0 or 1, especially preferably 0;

m₂, m₃, m₆ and m₇ each independently stands for an integer from 1 to 15; preferably from 1 to 4, more preferably from 1 to 3, especially preferably 2;

n₂, n₃, n₆ and n₇ each independently stands for an integer from 0 to 14; preferably from 0 to 4, more preferably 0 or 1, especially preferably 0;

m₄ and m₈ each independently stands for an integer from 1 to 20; preferably from 1 to 4, more preferably from 1 to 3, especially preferably 2; and

n₄ and n₈ each independently stands for an integer from 0 to 19, preferably from 0 to 4, more preferably 0 or 1, especially preferably 0.

The monomer having a cage structure according to the invention is preferably a compound represented by the above-described formula (II), (III), (V) or (VI), more preferably a compound represented by the formula (II) or (III), especially preferably a compound represented by the formula (III).

These compounds having a cage structure according to the invention may be used in combination. Two or more of the monomers having a cage structure according to the invention may be copolymerized.

The compounds having a cage structure according to the invention preferably have a sufficient solubility in an organic solvent. The solubility at 25° C. in cyclohexanone or anisole is preferably 3 mass % or greater, more preferably 5 mass % or greater, especially preferably 10 mass % or greater.

Examples of the compound having a cage structure according to the invention include polybenzoxazoles as described in JP-A-1999-322929, JP-A-2003-12802, and JP-A-2004-18593, quinoline resins as described in JP-A-2001-2899, polyaryl resins as described in JP-T-2003-530464 (the term “JP-T” as used herein means a published Japanese translation of a PCT patent application), JP-T-2004-535497, JP-T-2004-504424, JP-T-2004-504455, JP-T-2005-501131, JP-T-2005-516382, JP-T-2005-514479, JP-T-2005-522528, JP-A-2000-100808 and U.S. Pat. No. 6,509,415, polyadamantanes as described in JP-A-1999-214382, JP-A-2001-332542, JP-A-2003-252982, JP-A-2003-292878, JP-A-2004-2787, JP-A-2004-67877 and JP-A-2004-59444, and polyimides as described in JP-A-2003-252992 and JP-A-2004-26850.

Specific examples of the monomer having a cage structure and usable in the invention include, but not limited to, the following ones.

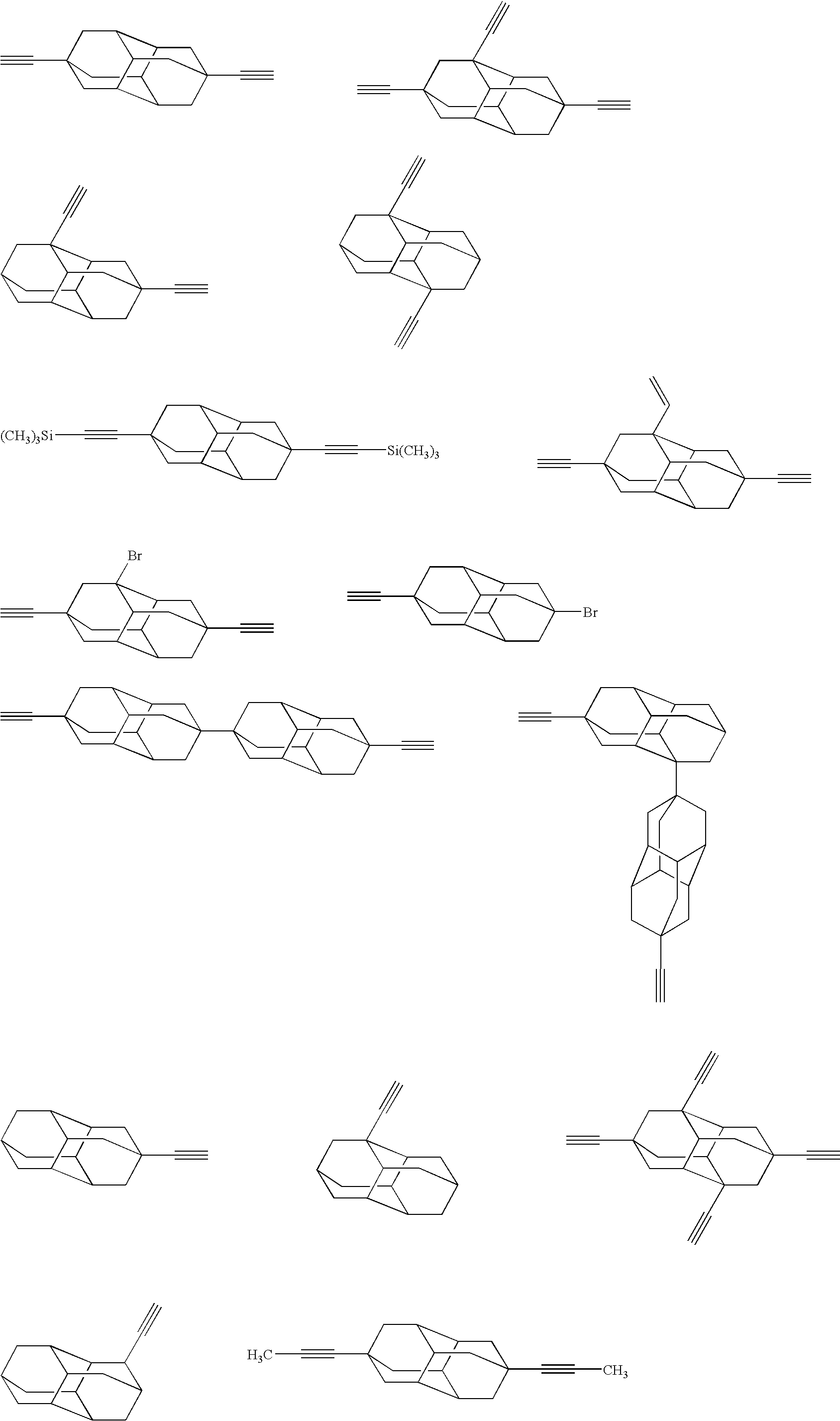

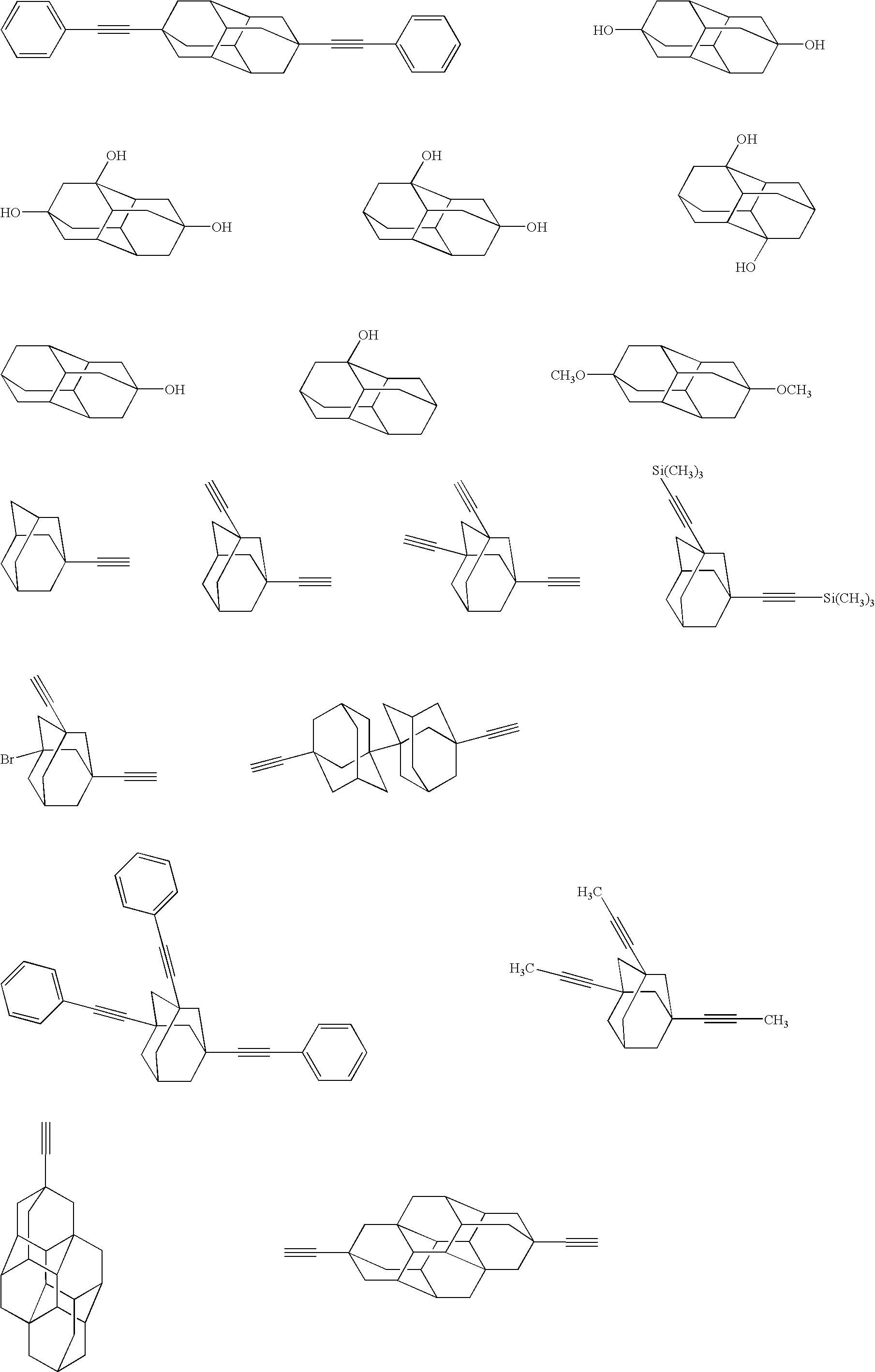

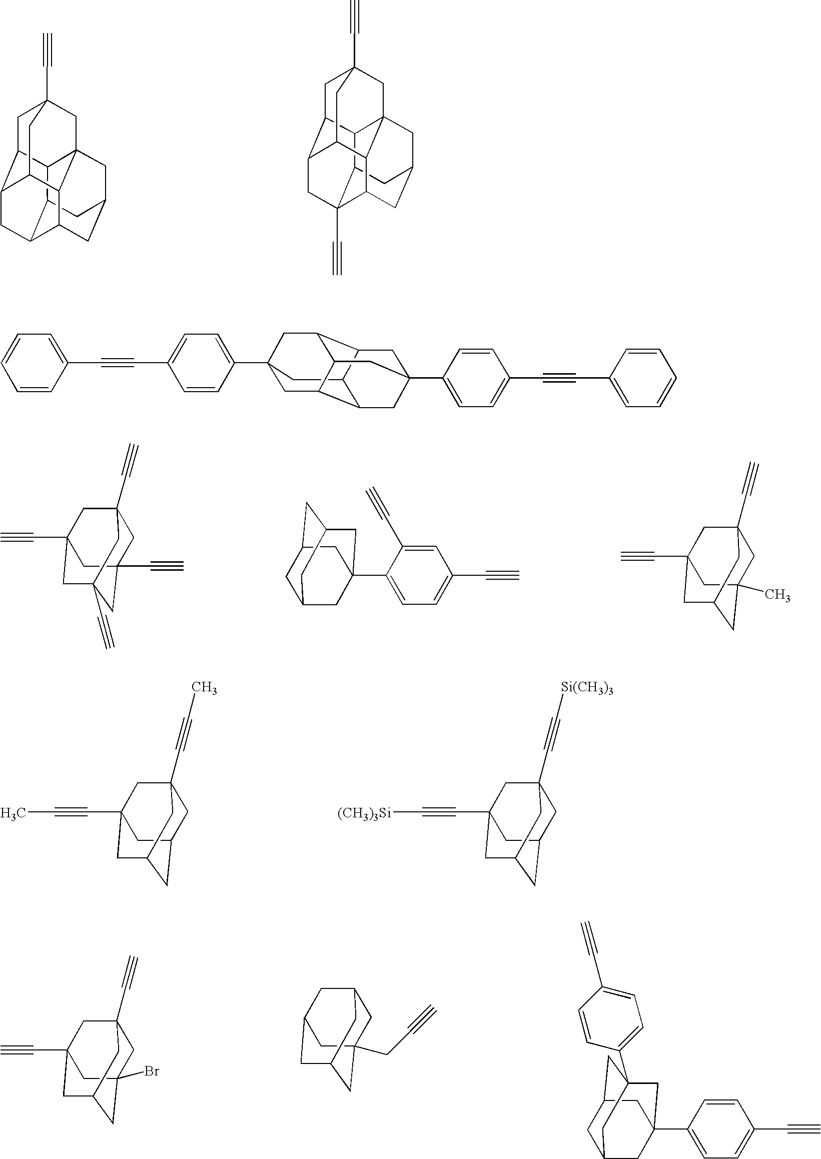

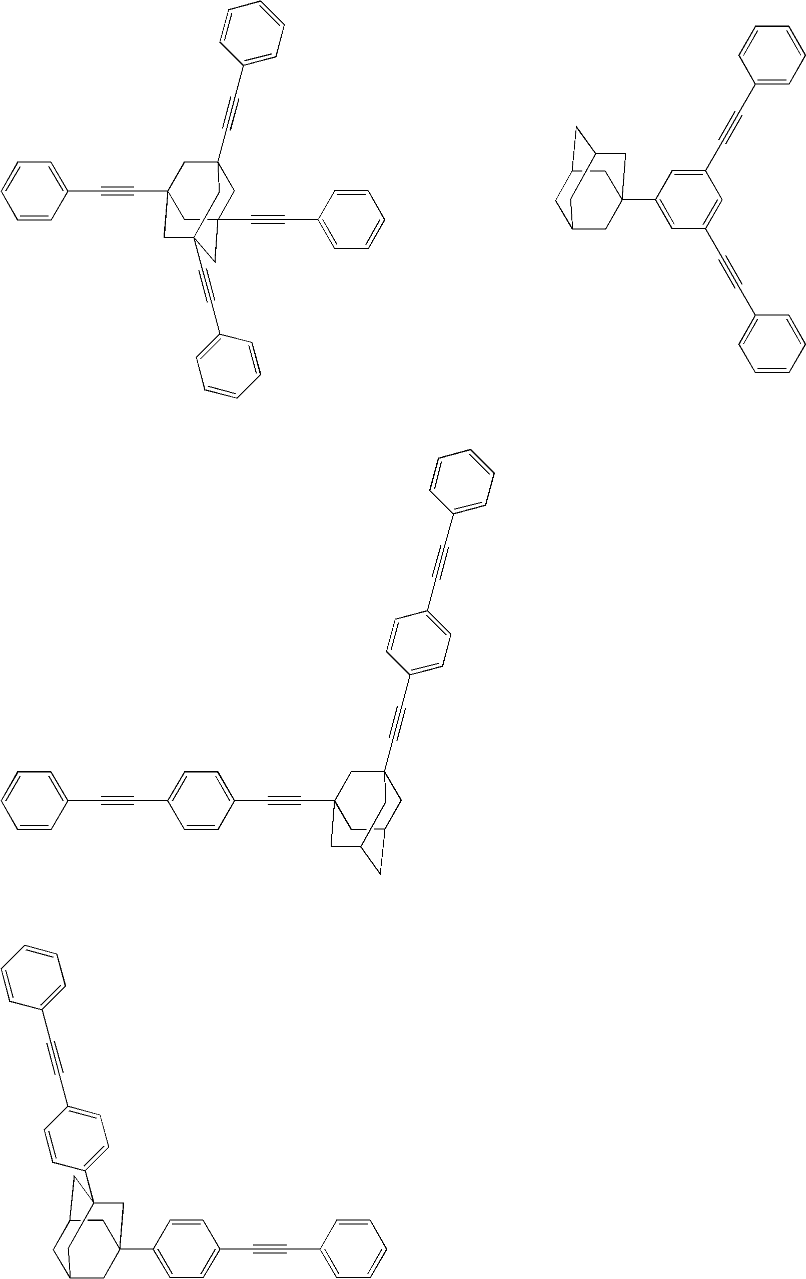

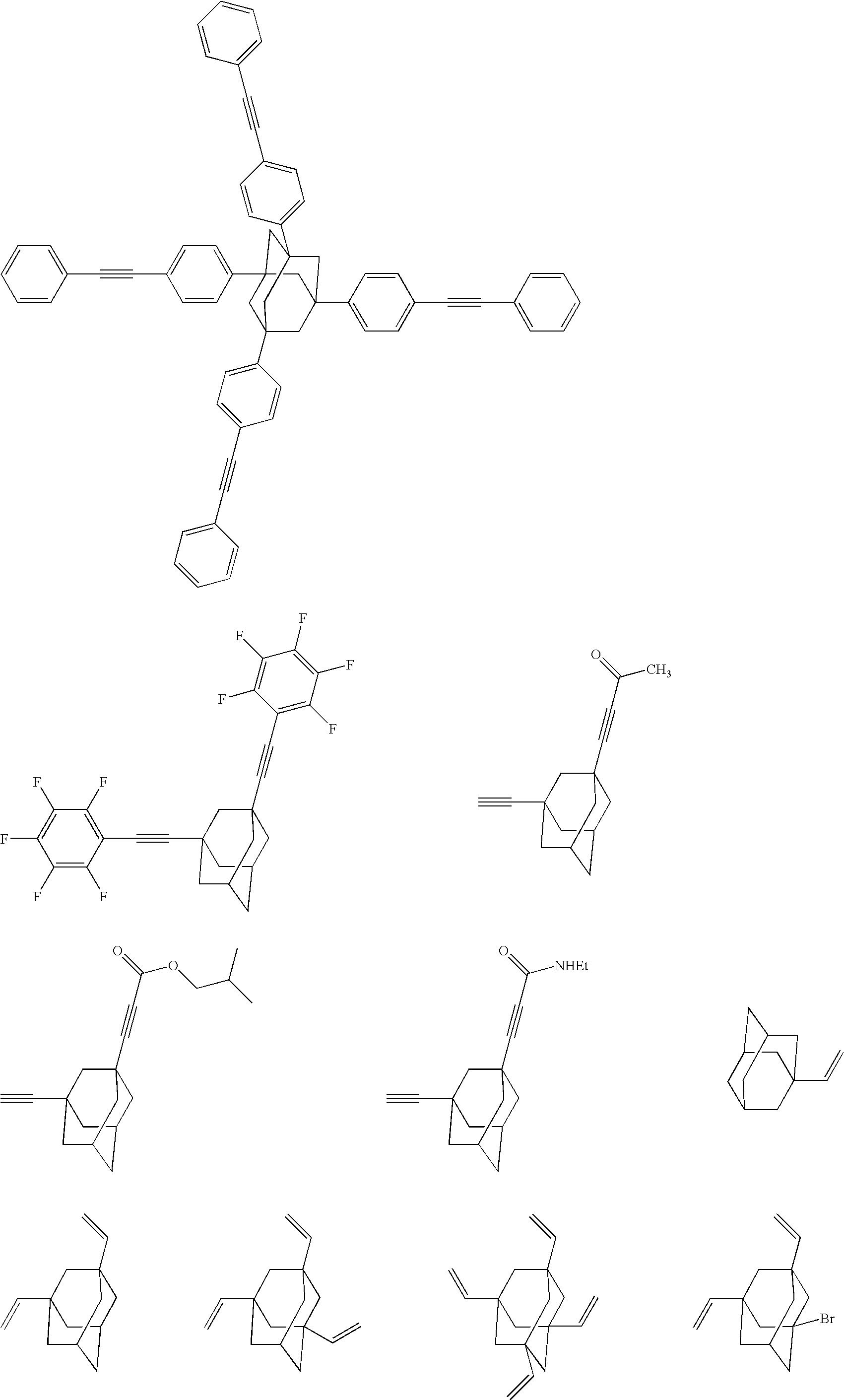

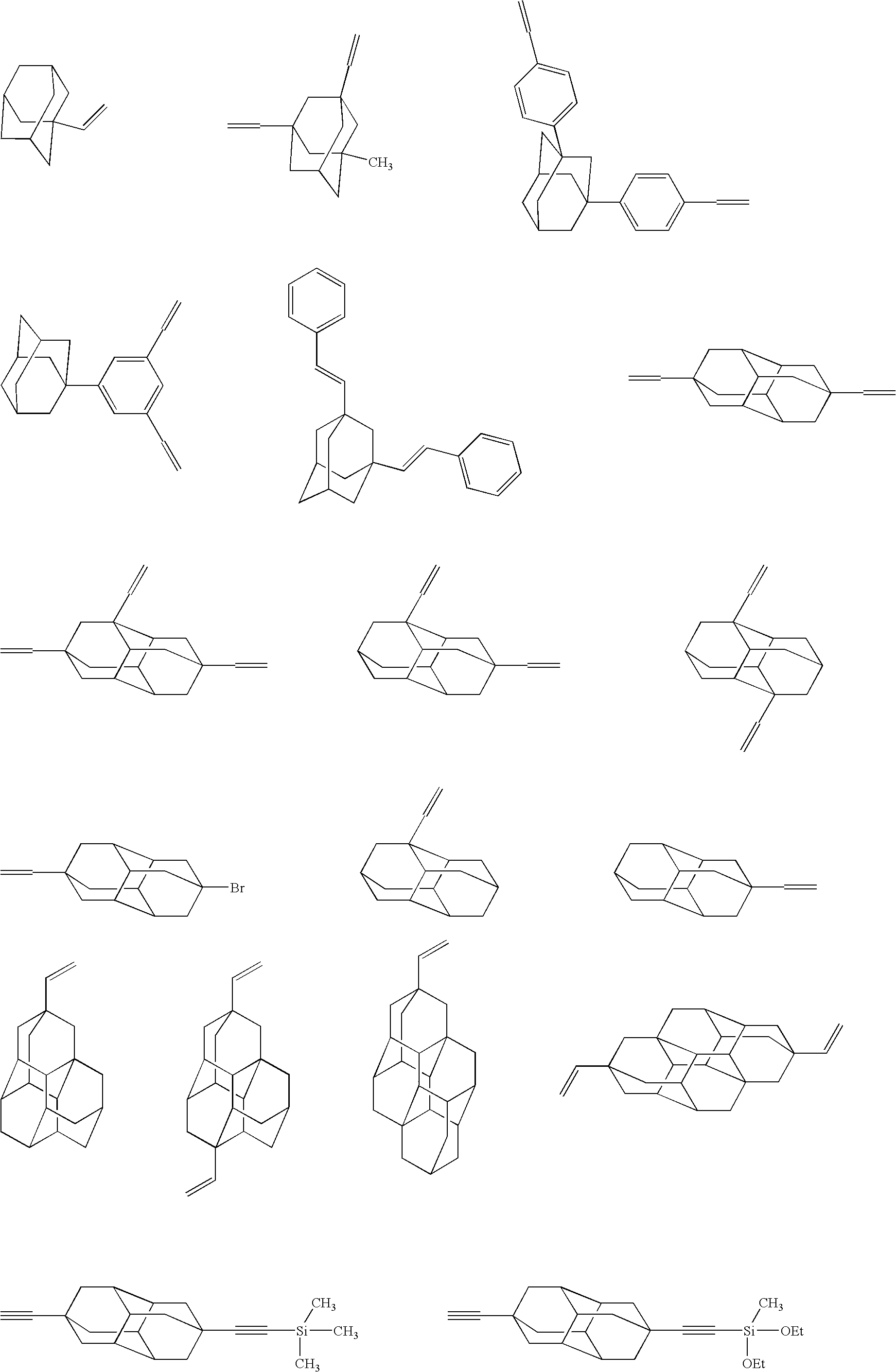

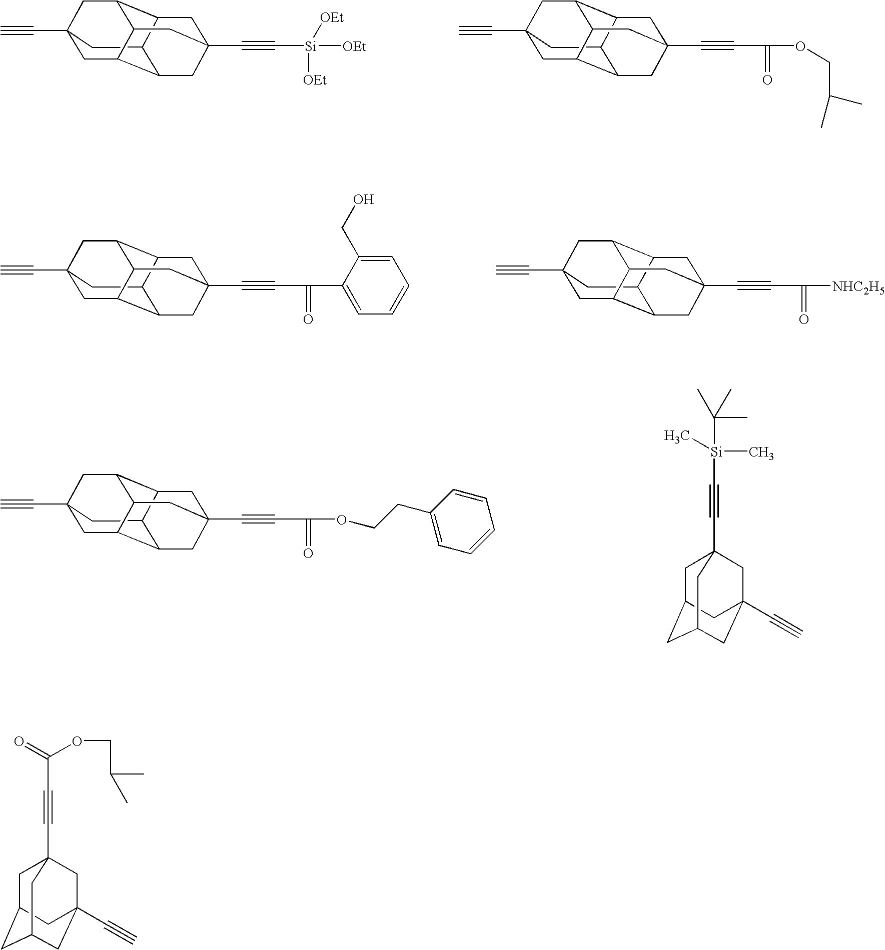

As the solvent used in the polymerization reaction, any solvent is usable insofar as it can dissolve a raw material monomer therein at a required concentration and has no adverse effect on the properties of a film formed from the polymer. Examples include water, alcohol solvents such as methanol, ethanol and propanol, ketone solvents such as alcohol acetone, methyl ethyl ketone, methyl isobutyl ketone, cyclohexanone and acetophenone; ester solvents such as ethyl acetate, butyl acetate, propylene glycol monomethyl ether acetate, γ-butyrolactone and methyl benzoate; ether solvents such as dibutyl ether and anisole; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene and 1,3,5-triisopropylbenzene; amide solvents such as N-methylpyrrolidinone and dimethylacetamide; halogen solvents such as carbon tetrachloride, dichloromethane, chloroform, 1,2-dichloroethane, chlorobenzene, 1,2-dichlorobenzene and 1,2,4-trichlorobenzene; and aliphatic hydrocarbon solvents such as hexane, heptane, octane and cyclohexane. Of these solvents, preferred are acetone, methyl ethyl ketone, methyl isobutyl ketone, cyclohexanone, acetophenone, ethyl acetate, propylene glycol monomethyl ether acetate, γ-butyrolactone, anisole, tetrahydrofuran, toluene, xylene, mesitylene, 1,2,4,5-tetramethylbenzene, isopropylbenzene, t-butylbenzene, 1,4-di-t-butylbenzene, 1,3,5-tri-t-butylbenzene, 4-t-butyl-orthoxylene, 1-methylnaphthalene, 1,3,5-triisopropylbenzene, 1,2-dichloroethane, chlorobenzene, 1,2-dichlorobenzene and 1,2,4-trichlorobenzene, of which tetrahydrofuran, γ-butyrolactone, anisole, toluene, xylene, mesitylene, isopropylbenzene, t-butylbenzene, 1,3,5-tri-t-butylbenzene, 1-methylnaphthalene, 1,3,5-triisopropylbenzene, 1,2-dichloroethane, chlorobenzene, 1,2-dichlorobenzene, and 1,2,4-trichlorobenzene are more preferred and γ-butyrolactone, anisole, mesitylene, t-butylbenzene, 1,3,5-triisopropylbenzene, 1,2-dichlorobenzene and 1,2,4-trichlorobenzene are especially preferred. These solvents may be used either singly or as a mixture.

The monomer concentration in the reaction mixture is preferably from 1 to 50 mass %, more preferably from 5 to 30 mass %, especially preferably from 10 to 20 mass %.

The conditions most suited for the polymerization reaction in the invention differ, depending on the kind or concentration of the polymerization initiator, monomer or solvent. The polymerization reaction is performed preferably at a bulk temperature of from 0 to 200° C., more preferably from 50 to 170° C., especially preferably from 100 to 150° C., preferably for 1 to 50 hours, more preferably from 2 to 20 hours, especially preferably from 3 to 10 hours.

To suppress the inactivation of the polymerization initiator which will otherwise occur by oxygen, the reaction is performed preferably in an inert gas atmosphere (for example, nitrogen or argon). The oxygen concentration upon reaction is preferably 100 ppm or less, more preferably 50 ppm or less, especially preferably 20 ppm or less.

The polymer obtained by the polymerization has a weight average molecular weight of preferably from 1000 to 500000, more preferably from 5000 to 200000, especially preferably from 10000 to 100000.

The compound having a cage structure according to the invention can be synthesized, for example, by using commercially available diamantane as a raw material, reacting it with bromine in the presence or absence of an aluminum bromide catalyst to introduce a bromine atom into a desired position of it, causing a Friedel-Crafts reaction between the resulting compound with vinyl bromide in the presence of a Lewis acid such as aluminum bromide, aluminum chloride or iron chloride to introduce a 2,2-dibromoethyl group, and then converting it into an ethynyl group by HBr elimination using a strong base. More specifically, it can be synthesized in accordance with the process as described in Macromolecules, 24, 5266-5268 (1991) and 28, 5554-5560 (1995), Journal of Organic Chemistry, 39, 2995-3003 (1974) and the like.

An alkyl group or silyl group may be introduced by making the hydrogen atom of the terminal acetylene group anionic by using butyl lithium or the like and then reacting the resulting compound with an alkyl halide or silyl halide.

In the invention, the above-described polymers may be used either singly or as a mixture.

No particular limitation is imposed on the coating solvent to be used in the invention. Examples include alcohol solvents such as methanol, ethanol, 2-propanol, 1-butanol, 2-ethoxymethanol, 3-methoxypropanol and 1-methoxy-2-propanol; ketone solvents such as acetone, acetylacetone, methyl ethyl ketone, methyl isobutyl ketone, 2-pentanone, 3-pentanone, 2-heptanone, 3-heptanone, cyclopentanone and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether solvents such as diisopropyl ether, dibutyl ether, ethyl propyl ether, anisole, phenetole and veratrole; aromatic hydrocarbon solvents such as mesitylene, ethylbenzene, diethylbenzene, propylbenzene and t-butylbenzene; and amide solvents such as N-methylpyrrolidinone and dimethylacetamide. These solvents may be used either singly or as a mixture.

Of these, preferred organic solvents are 1-methoxy-2-propanol, propanol, acetylacetone, cyclohexanone, propylene glycol monomethyl ether acetate, butyl acetate, methyl lactate, ethyl lactate, γ-butyrolactone, anisole, mesitylene, and t-butylbenzene, with 1-methoxy-2-propanol, cyclohexanone, propylene glycol monomethyl ether acetate, ethyl lactate, γ-butyrolactone, t-butylbenzene and anisole being especially preferred.

The solid concentration of the film forming composition to be used in the invention is preferably from 1 to 50 mass %, more preferably from 2 to 15 mass %, especially preferably from 3 to 10 mass %.

The content of metals, as an impurity, of the film forming composition of the invention is preferably as small as possible. The metal content of the film forming composition can be measured with high sensitivity by the ICP-MS and in this case, the content of metals other than transition metals is preferably 30 ppm or less, more preferably 3 ppm or less, especially preferably 300 ppb or less. The content of the transition metal is preferably as small as possible because it accelerates oxidation by its high catalytic capacity and the oxidation reaction in the prebaking or thermosetting process decreases the dielectric constant of the film obtained by the invention. The metal content is preferably 10 ppm or less, more preferably 1 ppm or less, especially preferably 100 ppb or less.

The metal concentration of the film forming composition can also be evaluated by subjecting a film obtained using the film forming composition of the invention to total reflection fluorescent X-ray analysis. When W ray is employed as an X-ray source, the metal concentrations of metal elements such as K, Ca, Ti, Cr, Mn, Fe, Co, Ni, Cu, Zn, and Pd can be measured. The concentrations of them are each preferably from 100×10¹⁰ atom·cm⁻² or less, more preferably 50×10¹⁰ atom·cm⁻² or less, especially preferably 10×10¹⁰ atom·cm⁻² or less. In addition, the concentration of Br as a halogen can be measured. Its remaining amount is preferably 10000×10¹⁰ atom·cm⁻² or less, more preferably 1000×100 atom·cm⁻², especially preferably 400×10¹⁰ atom·cm⁻². Moreover, the concentration of Cl can also be observed as a halogen. In order to prevent it from damaging a CVD device, etching device or the like, its remaining amount is preferably 100×10¹⁰ atom·cm⁻² or less, more preferably 50×10¹⁰ atom·cm⁻², especially preferably 10×10¹⁰ atom·cm⁻².

To the film forming composition of the invention, additives such as radical generator, colloidal silica, surfactant, silane coupling agent and adhesive agent may be added without impairing the properties (such as heat resistance, dielectric constant, mechanical strength, coatability, and adhesion) of an insulating film obtained using it.

Any colloidal silica may be used in the invention. For example, a dispersion obtained by dispersing high-purity silicic anhydride in a hydrophilic organic solvent or water and having usually an average particle size of from 5 to 30 nm, preferably from 10 to 20 nm and a solid concentration of from about 5 to 40 mass % can be used.

Any surfactant may be added in the invention. Examples include nonionic surfactants, anionic surfactants and cationic surfactants. Further examples include silicone surfactants, fluorosurfactants, polyalkylene oxide surfactants, and acrylic surfactants. In the invention, these surfactants can be used either singly or in combination. As the surfactant, silicone surfactants, nonionic surfactants, fluorosurfactants and acrylic surfactants are preferred, with silicone surfactants being especially preferred.

The amount of the surfactant to be used in the invention is preferably from 0.01 mass % or greater but not greater than 1 mass %, more preferably from 0.1 mass % or greater but not greater than 0.5 mass % based on the total amount of the film forming coating solution.

The term “silicone surfactant” as used herein means a surfactant containing at least one Si atom. Any silicone surfactant may be used in the invention, but it preferably has a structure containing an alkylene oxide and dimethylsiloxane, of which a silicone surfactant having a compound represented by the following chemical formula is more preferred:

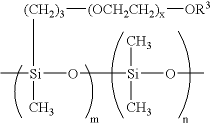

In the above formula, R³ represents a hydrogen atom or a C₁₋₅ alkyl group, x stands for an integer of from 1 to 20, and m and n each independently represents an integer of from 2 to 100. A plurality of R³s may be the same or different.

Examples of the silicone surfactant to be used in the invention include “BYK 306”, “BYK 307” (each, trade name; product of BYK Chemie), “SH7PA”, “SH21PA”, “SH28PA”, and “SH30PA” (each, trade name; product of Dow Corning Toray Silicone) and Troysol S366 (trade name; product of Troy Chemical).

As the nonionic surfactant to be used in the invention, any nonionic surfactant is usable. Examples include polyoxyethylene alkyl ethers, polyoxyethylene aryl ethers, polyoxyethylene dialkyl esters, sorbitan fatty acid esters, fatty-acid-modified polyoxyethylenes, and polyoxyethylene-polyoxypropylene block copolymers.

As the fluorosurfactant to be used in the invention, any fluorosurfactant is usable. Examples include perfluorooctyl polyethylene oxide, perfluorodecyl polyethylene oxide and perfluorododecyl polyethylene oxide.

As the acrylic surfactant to be used in the invention, any acrylic surfactant is usable. Examples include (meth)acrylic acid copolymer.

Any silane coupling agent may be used in the invention. Examples include 3-glycidyloxypropyltrimethoxysilane, 3-aminoglycidyloxypropyltriethoxysilane, 3-methacryloxypropyltrimethoxysilane, 3-glycidyloxypropylmethyldimethoxysilane, 1-methacryloxypropylmethyldimethoxysilane, 3-aminopropyltrimethoxysilane, 3-aminopropyltriethoxysilane, 2-aminopropyltrimethoxysilane, 2-aminopropyltriethoxysilane, N-(2-amino ethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-triethoxysilylpropyltriethylenetriamine, 10-trimethoxysilyl-1,4,7-triazadecane, 10-triethoxysilyl-1,4,7-triazadecane, 9-trimethoxysilyl-3,6-diazanonyl acetate, 9-triethoxysilyl-3,6-diazanonyl acetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, and N-bis(oxyethylene)-3-aminopropyltriethoxysilane. Those silane coupling agents may be used either singly or in combination. The silane coupling agent may be added preferably in an amount of 10 parts by weight or less, especially preferably from 0.05 to 5 parts by weight based on 100 parts by weight of the whole solid content.

In the invention, any adhesion accelerator may be used. Examples include trimethoxysilylbenzoic acid, γ-methacryloxypropyltrimethoxysilane, vinyltriacetoxysilane, vinyltrimethoxysilane, γ-isocyanatopropyltriethoxysilane, γ-glycidoxypropyltrimethoxysilane, β-(3,4-epoxycyclohexyl)ethyltrimethoxysilane, trimethoxyvinylsilane, γ-aminopropyltriethoxysilane, aluminum monoethylacetoacetate disopropylate, vinyltris(2-methoxyethoxy)silane, N-(2-aminoethyl)-3-aminopropylmethyldimethoxysilane, N-(2-amino ethyl)-3-aminopropyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, trimethylchlorosilane, dimethylvinylchlorosilane, methyldiphenylchlorosilane, chloromethyldimethylchlorosilane, trimethylmethoxysilane, dimethyldiethoxysilane, methyldimethoxysilane, dimethylvinylethoxysilane, diphenyldimethoxysilane, phenyltriethoxysilane, hexamethyldisilazane, N,N′-bis(trimethylsilyl)urea, dimethyltrimethylsilylamine, trimethylsilylimidazole, vinyltrichlorosilane, benzotriazole, benzimidazole, indazole, imidazole, 2-mercaptobenzimidazole, 2-mercaptobenzothiazole, 2-mercaptobenzoxazole, urazole, thiourasil, mercaptoimidazole, mercaptopyrimidine, 1,1-dimethylurea, 1,3-dimethylurea and thiourea compounds. A functional silane coupling agent is preferred as an adhesion accelerator. The amount of the adhesion accelerator is preferably 10 parts by weight or less, especially preferably from 0.05 to 5 parts by weight, based on 100 parts by weight of the total solid content.

It is also possible to add a pore forming factor to the film forming composition to be used in the invention to the extent allowed by the mechanical strength of the film in order to make the film porous and thereby reduce the dielectric constant of the film.

Although the pore forming factor which will be an additive serving as a pore forming agent is not particularly limited, non-metallic compounds are preferred. They must satisfy both solubility in the solvent used for a film forming coating solution and compatibility with the polymer of the invention. The boiling point or decomposition point of the pore forming agent is preferably from 100 to 500° C., more preferably from 200 to 450° C., especially preferably from 250 to 400° C. The molecular weight of it is preferably from 200 to 50000, more preferably from 300 to 10000, especially preferably from 400 to 5000. The amount of it in terms of mass % is preferably from 0.5 to 75%, more preferably from 0.5 to 30%, especially preferably from 1 to 20% relative to the film forming polymer. The polymer may contain a decomposable group as the pore forming factor. The decomposition point of it is preferably from 100 to 500° C., more preferably from 200 to 450° C., especially preferably from 250 to 400° C. The content of the decomposable group is, in terms of mole % relative to the amount of the monomer in the film forming polymer, from 0.5 to 75%, more preferably from 0.5 to 30%, especially preferably from 1 to 20%.

The film to be used in the invention can be formed by applying a coating solution composed of the film forming composition onto a substrate by a desired method such as spin coating, roller coating, dip coating or scan coating, and then heating the substrate to remove the solvent. As the method of applying the composition to the substrate, spin coating and scan coating are preferred, with spin coating being especially preferred. For spin coating, commercially available apparatuses such as “Clean Track Series” (trade name; product of Tokyo Electron), “D-Spin Series” (trade name; product of Dainippon Screen), or “SS series” or “CS series” (each, trade name; product of Tokyo Oka Kogyo) are preferably employed. The spin coating may be performed at any rotation speed, but from the viewpoint of in-plane uniformity of the film, a rotation speed of about 1300 rpm is preferred for a 300-mm silicon substrate. When the solution composed of the composition is discharged, either dynamic discharge in which the solution is discharged onto a rotating substrate or static discharge in which the solution is discharged onto a static substrate may be employed. The dynamic discharge is however preferred in view of the in-plane uniformity of the film. Alternatively, from the viewpoint of reducing the consumption amount of the composition, a method of discharging only the main solvent of the composition to a substrate in advance to form a liquid coating and then discharging the composition thereon can be employed. Although no particular limitation is imposed on the spin coating time, it is preferably within 180 seconds from the viewpoint of throughput. From the viewpoint of the transport of the substrate, treatment (such as edge rinse or back rinse) for preventing the remaining of the film at the edge portion of the substrate is preferably employed. The heat treatment method is not particularly limited, but ordinarily employed methods such as hot plate heating, heating with a furnace, heating in an RTP (Rapid Thermal Processor) or the like to expose the substrate to light of a xenon lamp can be employed. Of these, hot plate heating or heating with a furnace is preferred. As the hot plate, a commercially available one, for example, “Clean Track Series” (trade name; product of Tokyo Electron), “D-Spin Series” (trade name; product of Dainippon Screen) and “SS series” or “CS series” (trade name; product of Tokyo Oka Kogyo) is preferred, while as the furnace, “α series” (trade name; product of Tokyo Electron) is preferred.

When the film available according to the invention is used as an interlayer insulating film for semiconductor devices, the wiring structure thereof may have, on the side surface of an interconnect, a barrier layer for preventing metal migration. As well as a cap layer, interlayer adhesion layer and the like for preventing peeling at the time of CMP (chemical mechanical polishing), an etching stopper layer may be disposed on the upper or bottom surface of the interconnect or interlayer insulating film. Moreover, the interlayer insulating film may be composed of plural layers including another material as needed.

The film available according to the invention can be etched for copper interconnection or another purpose. Either wet etching or dry etching can be employed, but dry etching is preferred. For dry etching, either ammonia plasma or fluorocarbon plasma can be used as needed. For the plasma, not only Ar but also a gas such as oxygen, nitrogen, hydrogen or helium can be used. Etching may be followed by ashing for the purpose of removing a photoresist or the like used for etching. Moreover, the ashing residue may be removed by rinsing.

The film available according to the invention may be subjected to CMP for planarizing a copper plated portion after the copper wiring process. As the CMP slurry (chemical liquid), commercially available slurries (for example, products of Fujimi, Rodel-Nitta, JSR and Hitachi Chemical) are usable as needed. As the CMP apparatus, commercially available CMP apparatuses (for example, products of Applied Materials and Ebara) can be used as needed. The film may be rinsed after CMP in order to remove the slurry residue.

The film available according to the invention can be used for various purposes. For example, it is suited for use as an insulating film in semiconductor devices such as LSI, system LSI, DRAM, SDRAM, RDRAM and D-RDRAM, and in electronic devices such as multi-chip module multi-layered wiring board. It can also be used as a passivation film or an α-ray shielding film for LSI, a coverlay film for flexographic printing plate, an overcoat film, a cover coating for a flexible copper-clad board, a solder resist film, and a liquid crystal alignment film as well as an interlayer insulating film for semiconductor, an etching stopper film, a surface protective film, and a buffer coating film. Use of a stacked product obtained by stacking the insulating film is also suited.

For another purpose, the film of the invention doped with an electron donor or acceptor to make it conductive can be used as a conductive film.

### EXAMPLES

The present invention will next be described by the following Examples, but the scope of it is not limited by them.

### Example 1

In accordance with the synthesis process as described in Macromolecules, 5266(1991), 4,9-diethynyldiamantane was synthesized. Under a nitrogen gas stream, 2 g of the resulting 4,9-diethynyldiamantane, 0.22 g of dicumyl peroxide (“PERCUMYL D”, trade name; product of NOF) and 10 ml of t-butylbenzene were polymerized by stirring for 7 hours at a bulk temperature of 150° C. After the reaction mixture was cooled to room temperature, 60 ml of isopropyl alcohol was added. The solid thus precipitated was collected by filtration and rinsed with isopropyl alcohol sufficiently, whereby 0.8 g of a polymer (A) having a weight average molecular weight of about 15000 was obtained.

The polymer (A) had a solubility at 25° C. of 15 mass % or greater in cyclohexanone.

A coating solution was prepared by completely dissolving 1.0 g of the polymer (A) in 10 g of cyclohexanone. The resulting solution was filtered through a 0.1-μm filter made of PTFE, followed by spin coating on a silicon wafer. The coat thus obtained was heated at 200° C. for 60 seconds on a hot plate in a nitrogen gas stream to dry off the solvent. After exposure to ultraviolet (UV) radiation (nitrogen atmosphere, substrate temperature: 350° C., wavelength: from 220 to 600 nm, illuminance: 800 mW (240 to 320 nm)) with a high-pressure mercury lamp for 3 minutes, the silicon wafer was then floated from a heating stage by using a pin attached to the stage in a high-pressure mercury lamp apparatus and cooled to 140° C. The coat was then exposed further to electron beam (nitrogen atmosphere, pressure: 20 kPa, substrate temperature: 350° C., electron accelerating voltage: 20 kV, dose amount of electron beam: 1 μC cm⁻², “Mini-EB”, trade name; product of USHIO INC). As a result, a 0.5-μm thick uniform film free of seeding was obtained. The specific dielectric constant of the film was calculated based on the capacitance at 1 MHz by using a probe (product of Four Dimensions) and an LCR meter “HP4285A” (trade name; product of Yokogawa Hewlett-Packard). As a result, it was found to be 2.23. A Young's modulus of the film was measured using “Nanoindenter SA-2” (product of MTS Systems), resulting in 6.5 GPa. On the surface of the film, 5×5 squares each 3 mm on a side were scribed with a diamond pen and then, a Scotch® Tape (No. 610, product of 3M) was adhered to the substrate to cover all the squares therewith while preventing insertion of bubbles between the film and the tape. Then, an adhesion test (which will hereinafter be called “Scotch tape test”) of the insulating film to the Si substrate was performed by taking off the tape perpendicularly. As a result, no peeling occurred.

### Example 2

In a similar manner to Example 1 except that the exposure to electron beam was followed by the exposure to UV radiation, the evaluation was made. As a result, the film had a dielectric constant of 2.19 and Young's modulus of 5.8 GPa, and no peeling occurred in the Scotch tape test.

### Example 3

Under a nitrogen gas stream, 2 g of 4,9-diethynyldiamantane, 0.8 g of 1,1′-azobis(cyclohexane-1-carbonitrile) (“V-40”, trade name; product of Wako Pure Chemicals), and 10 ml of dichlorobenzene were polymerized by stirring for 8 hours at a bulk temperature of 100° C. After the reaction mixture was cooled to room temperature, 100 ml of methanol was added. The solid thus precipitated was collected by filtration and rinsed with methanol, whereby 1.0 g of a polymer (B) having a weight average molecular weight of about 10000 was obtained.

The polymer (B) had a solubility at 25° C. of 15 mass % or greater in cyclohexanone.

A coating solution was prepared by completely dissolving 1.0 g of the polymer (B) in 10 g of cyclohexanone. The resulting solution was filtered through a 0.1-μm filter made of PTFE, followed by spin coating on a silicon wafer. The coat thus obtained was heated at 250° C. for 60 seconds on a hot plate in a nitrogen gas stream and then, exposed to ultraviolet (UV) radiation (nitrogen atmosphere, substrate temperature: 350° C., wavelength: from 220 to 600 nm, illuminance: 800 mW (240 to 320 nm)) with a high-pressure mercury lamp for 3 minutes. The silicon wafer was floated from a heating stage by using a pin attached to the stage in a high-pressure mercury lamp apparatus and cooled to 140° C., followed by further exposure to electron beam (nitrogen atmosphere, pressure: 20 kPa, substrate temperature: 350° C., electron accelerating voltage: 20 kV, dose amount of electron beam: 1 μC cm⁻², “Mini-EB”, trade name; product of USHIO INC). As a result, a 0.5-μm thick uniform film free from seeding was obtained. The film had a specific dielectric constant of 2.22 and a Young's modulus of 6.3 GPa. In the Scotch tape test, no peeling occurred.

### Example 4

In a similar manner to Example 3 except the exposure to electron beam was followed by the exposure to UV radiation, evaluation was made. As a result, the film had a dielectric constant of 2.15 and Young's modulus of 6.2 GPa, and no peeling occurred in the Scotch tape test.

### Example 5

A coating solution was prepared with reference to EXAMPLE 3b (Polymer C) in the specification of U.S. Pat. No. 6,646,081. The resulting coating solution was filtered through a 0.2-μm filter made of PTFE, followed by spin coating on a silicon wafer. The coat thus obtained was heated at 110° C. for 90 seconds and at 200° C. for 60 seconds successively on a hot plate in a nitrogen gas stream, and then, exposed to ultraviolet (UV) radiation (nitrogen atmosphere, substrate temperature: 350° C., wavelength: 220 to 600 nm, illuminance: 800 mW (240 to 320 nm)) with a high-pressure mercury lamp for 3 minutes. The coat was exposed further to electron beam (nitrogen atmosphere, pressure: 20 kPa, substrate temperature: 350° C., electron accelerating voltage: 20 kV, dose amount of electron beam: 100 μC cm⁻², “Mini-EB”, trade name; product of USHIO INC). A 0.50-μm thick insulating film thus obtained had a specific dielectric constant of 2.73 and a Young's modulus of 4.3 GPa. On the surface of the film, 5×5 squares each 3 mm on a side were scribed with a diamond pen and then, Scotch tape test of the insulating film to the Si substrate was performed. As a result, 20 squares out of 25 squares remained without peeling. Electron microscope observation of the surface where peeling occurred revealed that the peeling occurred at the interface with the silicon wafer.

### Example 6

In a similar manner to Example 5 except that the exposure to electron beam was followed by the exposure to UV radiation, the evaluation was made. As a result, the film thus obtained had a dielectric constant of 2.72 and Young's modulus of 4.5 GPa, and 20 squares, out of 25 squares, remained without peeling. Electron microscope observation of the surface where peeling occurred revealed that peeling occurred at the interface with the silicon wafer.

### Comparative Example 1

In a similar manner to Example 1 except that the exposure to UV radiation was omitted, the evaluation was made. As a result, the film thus obtained had a dielectric constant of 2.35 and Young's modulus of 9 GPa. In the Scotch tape test, peeling occurred in every square. Electron microscope observation of the surface where peeling occurred revealed that breakage and peeling occurred not at the interface with the silicon wafer but on a slightly film side from the interface.

### Comparative Example 2

In a similar manner to Example 1 except that the exposure to UV radiation was omitted and exposure to electron beam was performed twice, the evaluation was made. As a result, the film thus obtained had a dielectric constant of 2.45 and Young's modulus of 8.5 GPa. In the Scotch tape test, peeling occurred in every square. Electron microscope observation of the surface where peeling occurred revealed that breakage and peeling occurred not at the interface with the silicon wafer but on a slightly film side from the interface.

### Comparative Example 3

In a similar manner to Example 1 except that the exposure to electron beam was not performed, the evaluation was made. As a result, the film thus obtained had a dielectric constant of 2.16 and Young's modulus of 5.5 GPa. In the Scotch tape test, peeling occurred in every square. Electron microscope observation of the surface where peeling occurred revealed that the peeling occurred at the interface with the silicon wafer.

### Comparative Example 4

In a similar manner to Example 1 except that the exposure to electron beam was omitted and exposure to UV radiation was performed twice, the evaluation was made. As a result, the film had a dielectric constant of 2.42 and Young's modulus of 5.8 GPa. In the Scotch tape test, peeling occurred in every square. Electron microscope observation of the surface where peeling occurred revealed that breakage and peeling occurred not at the interface with the silicon wafer but on a slightly film side from the interface.

### Comparative Example 5

In a similar manner to Example 5 except that the exposure to UV radiation was omitted, the evaluation was made. As a result, the film thus obtained had a dielectric constant of 2.75 and Young's modulus of 4.3 GPa. In the Scotch tape test, peeling occurred in every square. Electron microscope observation of the surface where peeling occurred revealed that the peeling occurred at the interface with the silicon wafer.

### Comparative Example 6

In a similar manner to Example 5 except that the exposure to electron beam was omitted, the evaluation was made. As a result, the film thus obtained had a dielectric constant of 2.72 and Young's modulus of 4.4 GPa. In the Scotch tape test, peeling occurred in every square. Electron microscope observation of the surface where peeling occurred revealed that the peeling occurred at the interface with the silicon wafer.

The results of Examples and Comparative Examples are shown in Table 1. As is apparent from Table 1, insulating films having a low dielectric constant and excellent in adhesion property and mechanical strength is available according to the present invention.

TABLE 1

| | | First | Second | Dielectric | Young's | Adhesion (number of |
|---|---|---|---|---|---|---|
| | Polymer | exposure | exposure | constant | modulus | remaining squares) |
| Ex. 1 | A | UV | Electron | 2.23 | 6.5 | 25/25 |
| | | | beam | | | |
| Ex. 2 | A | Electron | UV | 2.19 | 5.8 | 25/25 |
| | | beam | | | | |
| Ex. 3 | B | UV | Electron | 2.22 | 6.3 | 25/25 |
| | | | beam | | | |
| Ex. 4 | B | Electron | UV | 2.15 | 6.2 | 25/25 |
| | | beam | | | | |
| Ex. 5 | C | UV | Electron | 2.73 | 4.3 | 20/25 Interfacial peeling |
| | | | beam | | | |
| Ex. 6 | C | Electron | UV | 2.72 | 4.5 | 20/25 Interfacial peeling |
| | | beam | | | | |
| Comp. | A | Electron | None | 2.35 | 9 | 0/25 peeling in the film |
| Ex. 1 | | beam | | | | |
| Comp. | A | Electron | Electron | 2.45 | 8.5 | 0/25 peeling in the film |
| Ex. 2 | | beam | beam | | | |
| Comp. | A | UV | None | 2.16 | 5.5 | 0/25 Interfacial peeling |
| Ex. 3 | | | | | | |
| Comp. | A | UV | UV | 2.42 | 5.8 | 0/25 Interfacial peeling |
| Ex. 4 | | | | | | |
| Comp. | C | Electron | None | 2.75 | 4.3 | 0/25 Interfacial peeling |
| Ex. 5 | | beam | | | | |
| Comp. | C | UV | None | 2.72 | 4.4 | 0/25 Interfacial peeling |
| Ex. 6 | | | | | | |

The present invention makes it possible to provide a production process of an insulating film good in film properties such as dielectric constant, adhesion, mechanical strength and heat resistance; an insulating film produced in accordance with the above-described production process; a stacked product obtained by stacking the insulating film; and an electronic device produced using the insulating film or stacked product.

The entire disclosure of each and every foreign patent application from which the benefit of foreign priority has been claimed in the present application is incorporated herein by reference, as if fully set forth.

What is claimed is:

1. A production method of an insulating film, comprising:
a process of applying a film forming composition to form a film; and
a process of irradiating the film with at least two kinds of high energy rays to cure the film.

2. The production method according to claim 1,
wherein the at least two kinds of high energy rays are selected from the group consisting of electron beam, ultraviolet ray, X-ray and microwave.

3. The production method according to claim 1,
wherein the film is heated to 150 to 400° C. at the process of irradiating film.

4. The production method according to claim 3, further comprising:
a process of cooling the film to less than 150° C. between respective irradiations of the film with respective high energy rays.

5. The production method according to claim 1,
wherein the film forming composition comprises a compound having a cage structure.

6. The production method according to claim 5,
wherein the compound having a cage structure is a polymer of a monomer having a cage structure.

7. The production method according to claim 6,
wherein the monomer having a cage structure has a polymerizable carbon-carbon double bond or carbon-carbon triple bond.

8. The production method according to claim 5,
wherein the cage structure is selected from the group consisting of adamantane, biadamantane, diamantane, triamantane and tetramantane.

9. The production method according to claim 6,
wherein the monomer having a cage structure is selected from the group consisting of compounds represented by the following formulas (I) to (VI): 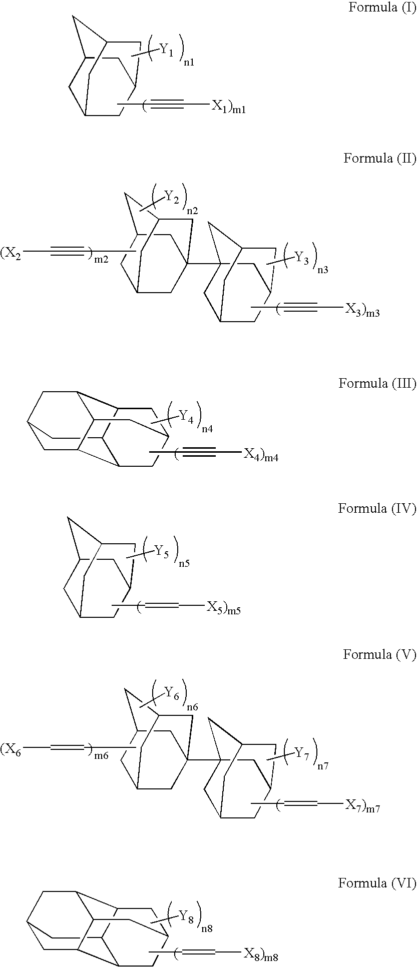
wherein, X₁(s) to X₈(s) each independently represents a hydrogen atom, C₁₋₁₀ alkyl group, C₂₋₁₀ alkenyl group, C₂₋₁₀ alkynyl group, C₆₋₂₀ aryl group, C₀₋₂₀ silyl group, C₂₋₁₀ acyl group, C₂₋₁₀ alkoxycarbonyl group, or C₁₋₂₀ carbamoyl group;
Y₁(s) to Y₈(s) each independently represents a halogen atom, C₁₋₁₀ alkyl group, C₆₋₂₀ aryl group or C₀₋₂₀ silyl group;
m₁ and m₅ each independently represents an integer of 1 to 16;
n₁ and n₅ each independently represents an integer of 0 to 15;
m₂, m₃, m₆ and m₇ each independently represents an integer of 1 to 15;
n₂, n₃, n₆ and n₇ each independently represents an integer of 0 to 14;
m₄ and m₈ each independently represents an integer of 1 to 20; and
n₄ and n₈ each independently represents an integer of 0 to 19.

10. The production method according to claim 6,
wherein the compound having a cage structure is obtained by polymerizing the monomer having a cage structure in the presence of a transition metal catalyst or a radical polymerization initiator.

11. The production method according to claim 5,
wherein the compound having a cage structure has a solubility of 3 mass % or greater in cyclohexanone or anisole at 25° C.

12. An insulating film produced by the production method according to claim 1.

13. A stacked product obtained by stacking the insulating film according to claim 12.

14. An electronic device comprising:
the insulating film according to claim 12.

15. An electronic device comprising:
the stacked product according to claim 13.
